(19) United States
(12) Patent Application Publication
(10) Pub. No.: US 2022/0358176 A1
(43) Pub. Date: Nov. 10, 2022

(54) SYSTEM AND METHOD OF MERGING ONLINE SEARCH AND CONSOLIDATION

(71) Applicant: Noah Greenburger, Ghent, NY (US)

(72) Inventor: Noah Jerome Greenburger, Ghent, NY (US)

(21) Appl. No.: 17/315,299

(22) Filed: May 8, 2021

(51) Int. Cl. G06F 16/9538; G06N 20/00; G06F 16/901

(52) U.S. Cl. CPC G06F 16/9538; G06N 20/00; G06F 16/901

(57) ABSTRACT

A system is provided for aggregating and presenting content drawn from diverse online providers. The system comprises a processor, a memory, and an application stored in the memory that when executed on the processor receives a request for electronic content available from a plurality of online providers. The system also connects to application programming interfaces (API) of multiple candidate online providers of the plurality of online providers to perform content searches. The system also deploys artificial intelligence to consolidate results of performed content searches and presents the consolidated results in a single listing. The content searches locate at least one of physical content and electronic content. The physical content comprises goods and services comprising at least one of food, shopping, and transportation. The electronic content comprises at least one of textual, video, and audio material. The application prompts clients to import their existing search histories from search platforms used.

### FIELD OF THE INVENTION

The present disclosure is in the field of online search. More particularly, the present disclosure provides systems and methods of customizing application programming interfaces (API) based on user watch lists to locate and present Internet search results in a single listing for user enjoyment.

### BACKGROUND

Searching the Internet for music, video, transportation, and delivery services is presently an onerous and time-consuming process. A person desiring information from a multitude of sources must manually locate and individually enter Internet web sites for many different providers to locate the material he/she needs. Received content is difficult to organize and store. Once stored, the content may be difficult or impossible for the user to locate again.

### BRIEF DESCRIPTION OF THE FIGURE

FIG. 1 is a block diagram of a system of merge online search and consolidation in accordance with an embodiment of the present disclosure.

### DETAILED DESCRIPTION

Systems and methods provided herein assist Internet users wanting to simultaneously locate electronic content across multiple apps and online sources. They may search for and rapidly receive results from video and music streaming, delivery of goods and services, messaging, ecommerce and social media. Multiple platforms are searched simultaneously across a diverse array of market sectors.

Web search artificial intelligence is applied to general databases. The system crawls databases and plugs into application programming interfaces (API) of web sites providing products commonly desired by web users.

Using at least one customized API developed for iOS platforms, systems and methods access the APIs of web sites and perform custom searches requested against well-known providers as well as small, new and unfamiliar sources. Users are encouraged to import their existing search histories from all of their platforms to the system. Users are then presented search results from numerous web sites in a single listing.

A user is enabled to compare transportation fares across Uber, Lyft and more. The user may search his/her streaming accounts for favorite movies and view his/her watch lists in one place. The user may order food from nearly any establishment that delivers through nearly any app. The user may find his/her favorite music in one simple search.

Buying records, tapes or CDs are all now a thing of the past. Music, one of the largest and most lucrative industries is now almost exclusively digital. With the release of multiple music streaming services, systems and methods provided herein make it easy for users to find the music they want. Merge searches for the highest quality versions of music that is available.

For video selection, Netflix, Hulu, HBO Now, Showtime, Starz, and Disney on Demand are searchable. Entertainment hosting is becoming more decentralized. Merge is here to help users find the content they desire to consume, quickly and easily. Merge mixes, matches and combines a user's playlists and stations across many platforms. All of a user's watch lists are kept in one place.

From food delivery platforms to blogs, the Internet hosts a great deal of new data points for consumers to search through. Merge plans to expand into additional markets with the aim of making interfacing with the internet simpler.

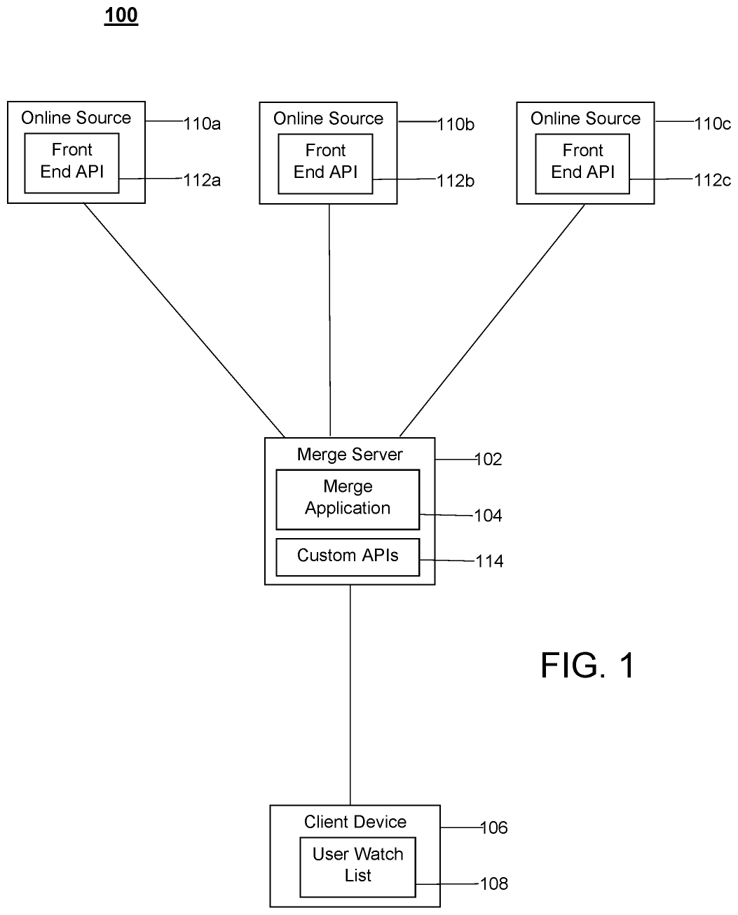

Turning to the FIGURE, FIG. 1 is a block diagram of a system of merge online search and consolidation in accordance with an embodiment of the present disclosure. FIG. 1 illustrates components and interactions of a system 100 provided herein.

The system 100 comprises a merge server 102 and a merge application 104, referred to herein for brevity as the server 102 and the application, respectively. The system 100 also comprises a client device 106 and a user watch list 108, although in embodiments many such components are in effect.

The system 100 also comprises online sources 110a-c and front-end APIs 112a-c resident thereon, although in embodiments many more than three of each such components are in effect. The system 100 also comprises customer APIs 114.

The server 102 may be a single or many physical computers situated in one or many geographic locations. The application 104 executes on the computer 102 and provides much of the functionality described herein. The server 102 receives requests from the client device 106 along with at least one user watch list 108 to search for and consolidate internet content available from many online sources 110a-c. The server may develop at least one custom API 114 to conduct the desired search. The at least one customer API 114 interfaces or plugs into at least one front end API 112a-c of online sources 110a-c to search content of the sources 110a-c. Search results are consolidated into search indexes that are used to for subsequent searching. In some cases, the custom APIs 114 are layered to provide a more accurate search based on specifics of a user watch list 108. Service aspects are aggregated. Scraping tools that may be bots to search for APIs are also deployed.

What is claimed is:

1. A system for aggregating and presenting content drawn from diverse online providers, comprising:
a processor;
a memory; and
an application stored in the memory that when executed on the processor:
receives a request for electronic content available from a plurality of online providers,
connects to application programming interfaces (API) of multiple candidate online providers of the plurality of online providers to perform content searches,
deploys artificial intelligence to consolidate results of performed content searches, and
presents the consolidated results in a single listing.

2. The system of claim 1, wherein the content searches locate at least one of physical content and electronic content.

3. The system of claim 2, wherein the physical content comprises goods and services comprising at least one of food, shopping, and transportation.

4. The system of claim 2, wherein the electronic content comprises at least one of textual, video, and audio material.

5. The system of claim 1, wherein the application prompts clients to import their existing search histories from search platforms used.

6. The system of claim 1, wherein the system is directed to iOS platforms.

7. The system of claim 6, wherein a customer application programming interface (API) executing on iOS platform devices plugs into front ends of application programming interfaces (API) of the candidate online providers.

8. The system of claim 1, wherein the system promotes search across selected streaming apps and digital services.

9. A system for generating search content across a plurality of online provider sources, comprising:
a computer;
an application executing on the computer that:
receives a message from a client device, the message requesting a customized listing of search results across a plurality of online providers,
receives, based on instructions to the client device, an import of search histories from search platforms used by the client device,
accesses application programming interfaces (API) of online providers appearing frequently in the search histories to perform content searches,
consolidates search results using artificial intelligence, and
sends the search results to the client device in a consolidated single listing.

10. The system of claim 9, wherein the search results comprise at least one of textual, video, and audio material.

11. The system of claim 9, wherein the system is directed to iOS platforms.

12. The system of claim 11, wherein a customer application programming interface (API) executing on iOS platform devices plugs into front ends of application programming interfaces (API) of the online providers.

13. The system of claim 9, wherein the system promotes search across selected streaming apps and digital services.

14. The system of claim 9, wherein the system consolidates search results into search indexes.

15. A method for aggregating and presenting content accessed from online sources, comprising:
a computer receiving a message from a client device requesting consolidated search content from a plurality of Internet providers
the computer requesting and receiving watch list content from the client device;
the computer using at least one customer application programming interface (API) to search for the content;
the computer consolidating search results using artificial intelligence, and the computer sending the search results to the client device in a consolidated single listing.

16. The method of claim 15, wherein the search using the at least one customer application programming interface (API) is based at least on the watch list content.

17. The method of claim 15, wherein the search results comprise at least one of textual, video, and audio material.

18. The method of claim 15, wherein the method is directed to iOS platforms.

19. The method of claim 15, further comprising the method promoting search across selected streaming apps and digital services.

20. The method of claim 15, further comprising the method consolidating search results into search indexes.
